(19) United States
(12) Patent Application Publication
(10) Pub. No.: US 2021/0069899 A1
(43) Pub. Date: Mar. 11, 2021

(54) METHOD FOR VALIDATING PROGRAMMED EXECUTION SEQUENCES OR TEACHING PROGRAMS FOR A ROBOT IN A WORKING CELL, AND ROBOT AND/OR ROBOT CONTROLLER FOR SAID METHOD

(71) Applicant: WITTMANN KUNSTSTOFFGERÄTE GMBH, Wien (AT)

(72) Inventor: Peter Michael WITTMANN, Leobendorf (AT)

(73) Assignee: WITTMANN KUNSTSTOFFGERÄTE GMBH, Wien (AT)

(21) Appl. No.: 16/772,361

(22) PCT Filed: Dec. 5, 2018
(86) PCT No.: PCT/AT2018/060286

§ 371 Date: Jun. 12, 2020

(30) Foreign Application Priority Data
Dec. 14, 2017 (AT) GM50221/2017

(51) Int. Cl. B25J 9/16; B25J 13/06

(52) U.S. Cl. CPC B25J 9/163; B25J 13/06

(57) ABSTRACT

The invention relates to a method and a robot (5) and/or robot controller (17) for validation of programmed workflow sequences and/or teaching programs (20) of the robot (5) in a work cell (2), wherein the robot (5) is preferably mounted on or next to a processing machine, in particular an injection molding machine (4), and designed for the extraction, handling, manipulation or further processing of injection-molded parts (3) which have just been produced. The robot controller (17) is designed to reproduce a virtual twin or robot model (21), respectively, in particular a virtual representation of the plant or work cell (2), respectively, at the output location, in particular a display or touch screen (16), whereby at least the injection molding machine is represented as part of the work cell, and further production resources of the plant or work cell (2), which are preferably automatically detected and represented.

The invention relates to a method for validation of programmed workflow sequences or teaching programs of the robot in a work cell, and a robot and/or robot controller therefor, as described in the preambles of claims 1 and 13.

Workflow sequences of industrial robots are typically first programmed directly with the aid of the robot controller or created on an external computer, in which case the physical positions in space must be defined in a second step. These definitions can also be made as part of the validation of the workflow sequence. Likewise, the validation of the sequence for future automatic operation is carried out after program creation either directly on the physical robot or in two separate steps. In the first step, the basic sequence is verified offline on the external computer, and in a further step it is on the physical robot in order to check the correctness of the positions and hardware functions.

A disadvantage of validation directly on the robot is that the axis movements must be performed on the physical robot and thus collisions with components in the work cell can occur, even if the validation is typically performed at reduced speed.

Furthermore, this validation is limited to program paths that are defined by current operating states. Offline validation on an external computer, on the other hand, has to be criticized for the limited visualization of the actual conditions, as well as the requirement for a high degree of imagination on the part of the operator with regard to the robot's overall workflow in the context of its environment. This again leads to an increased risk of collision during actual validation on the object after the workflow sequence has been transferred to the physical robot.

The objective of the present invention is therefore to create a method and a robot and/or robot controller system of the type mentioned above, which on the one hand avoids the disadvantages described above and on the other hand increases the user-friendliness of the systems, in particular for programming the system.

The objective is achieved by the invention.

The device according to the present invention is characterized in that the robot controller is designed to reproduce a virtual twin, in particular a virtual representation of the plant or work cell, respectively, at the output location, in particular a touch screen, wherein at least the injection molding machine is represented as part of the work cell, as well as further production resources of the plant or work cell, which are preferably automatically detected and represented. The advantage of this is that it makes it possible to check the sequence and subsequently the robot's traverse paths before actual start-up of the robot, based on the actual workflow sequence to be executed by the robot. This prevents unforeseen collisions. Even in case of program changes, where sequences are often deleted or inserted and adjustments are made to increase plant speeds, these can be checked beforehand on the virtual model. Another major advantage is that when a partial programming is completed, this part of the program can already be checked, without the entire teach-in program having to be created first. This allows the machine setter or programmer, respectively, to carry out programming and checking step by step.

Further advantageous embodiments are such where virtual models of production resources of the work cell are stored in the robot controller, in particular in a storage system, in particular their shape and dimensions. This ensures that representation of the virtual robot model is realistic as possible.

An advantageous embodiment is one in which data for the design, in particular the arrangement, form and function, as well as a digital representation of the production resources, are stored in the individual recorded means of production, which can be queried by the robot controller and/or the robot via a processing network. This makes it possible to easily take this into account when replacing or renewing a device with possibly changed parameters and/or sizes.

An advantageous embodiment is one where the perspective of the virtual twin or robot model, respectively, shown is freely selectable in order to easily find or check possible sources of error. This means that the operator or machine setter, respectively, can adjust any desired viewing angle on the system and can thus easily visually inspect areas that are difficult to access and view.

An advantageous embodiment is one where the virtual robot can be coupled with the physical robot again and again after the simulation of various commands of the robot control system and thereupon a further simulation run with different states can be executed. This ensures that the simulation is repeated in different situations. This allows various program paths of the workflow sequence to be tested.

An advantageous embodiment is one where the robot control system can be switched to simulation mode via a test button, in which mode parts of a robot program or teaching program or the complete teaching program, respectively, are/is simulated. This provides an easy way for checking the process on the virtual model.

An advantageous embodiment is one in which preferably a bright frame is displayed on the screen of the robot control system to distinguish the virtual robot model from the real equipment, i.e. the physical robot. This ensures that the operator can see at a glance that the simulation is running on the virtual model.

In an advantageous embodiment the robot controller activates its anti-collision control in manual mode and during a dry cycle. This means that in addition to the previous or currently running validation of the workflow sequence, respectively, permanent collision monitoring is carried out with the aid of distance sensors mounted at different positions on the robot arms.

An advantageous embodiment is one where the robot controller uses the distance sensors of the anti-collision control for the automatic acquisition of the workspace and thus does not depend on the transfer of data from the production resource for the generation of the virtual workspace. The automatically captured workspace is used in the simulation for detection of possible collision states.

A particularly advantageous embodiment is one in which the validation of the workflow sequences to be executed by the real robot is possible in a virtual manner at any time on the robot controller. This allows all processes to be run through before start-up of the system, so that collisions or other errors can be easily detected. This prevents damage to the actual system.

An advantageous embodiment is one where the robot controller reads the actual configuration data of the robot and links or combines them, respectively, with the teaching program stored in the robot controller. This ensures that the simulation is always carried out with the values or parameters, respectively, of the real components.

An advantageous embodiment is one in which the robot control system, in particular the touch surface, is designed to support gesture control, in particular wiping for changing sides and zooming with two fingers. Thus, user-friendliness is significantly simplified and enhanced.

An advantageous embodiment is one where, whenever defined limit values are exceeded, the corresponding components are displayed, in the virtual robot model in color, in particular red. This ensures that the operator or machine setter, respectively, can see immediately where dangers occur and can examine these areas more closely.

Furthermore, the objective of the present invention is also achieved by a method for validation of programmed workflow sequences or teaching programs of a robot preferably with a robot controller, in which a virtual robot model, in particular a digital twin, which reproduces the image of the actual robot and/or the plant or work cell, respectively, is represented in the robot controller and/or in the robot, wherein all the required data are queried and read out by the robot controller from the connected components, in particular the robot, the processing machine, the tool, etc., for the generation of the virtual plant model.

The advantage here is that damage to a real plant can be avoided in a simple manner, since the processes can be simulated directly on the plant beforehand. Since the simulation is possible directly at the robot controller of the plant, a comparison with the real state is easily possible.

However, advantageous embodiments are also such in which the robot controller is switched to a simulation mode in which all processes are reproduced in a virtual manner, taking into account the data requested and the program or teaching program created, respectively. Thus, the production workflow can be repeated as often as desired and, for example, can be followed from a different perspective each time.

Advantageous embodiments are such in which the robot controller uses stored configuration data from the physical robot to create the virtual robot. In this way, a virtual model that is as close to reality as possible can be created.

Also advantageous, however, are those embodiments in which data for the design, in particular the arrangement, form and function, as well as a digital representation of the production resources are stored in the individual recorded production resources, which can be queried by the robot controller and/or the robot via a processing network. This ensures that whenever a model is exchanged for a newer modified version, the robot controller is again supplied with all the necessary data to adapt the virtual robot model or twin, respectively.

Advantageous embodiments are such in which the displayed perspective of the digital twin can be changed at will for better detection or pinpointing, respectively, of faults. This allows the operator to zoom into areas of the plant that cannot be seen and thus control these areas.

Advantageous embodiments are such in which the robot controller and/or the robot can be switched to a simulation mode in which a processing machine, in particular an injection molding machine, is simulated on the basis of stored characteristic values in order to detect serious errors in the robot program before start-up of the processing machine.

Finally, embodiments in which the digital twin or virtual robot model, respectively, in particular the data, can be transferred to an external component, such as a PC or laptop, are advantageous. This ensures that the data can also be checked offline or sent to the manufacturer, respectively, who can then check and optimize the programming of the system in-house.

Basically, it can be said that the solution according to the present invention ensures that all sources of error can be easily detected and eliminated before start of production.

The invention will now be explained in more detail by reference to several exemplary embodiments illustrated in the drawings.

The figures show:

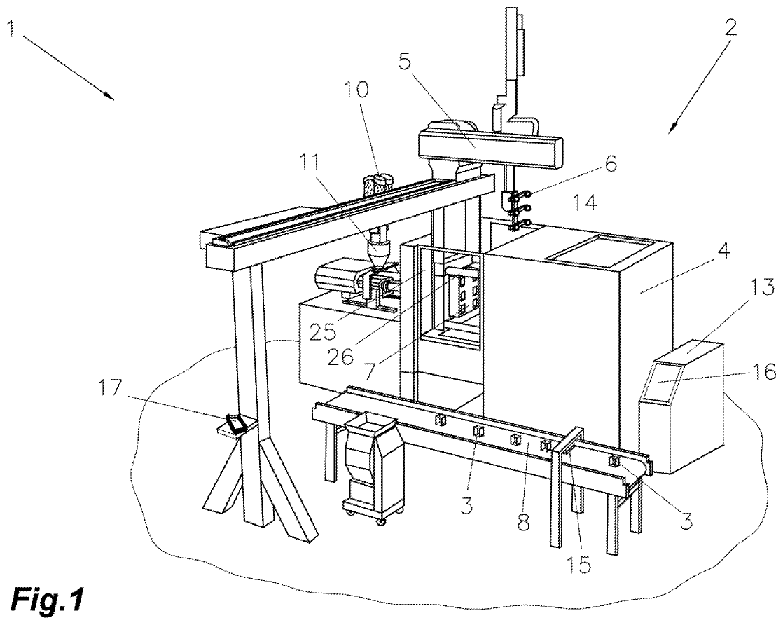

FIG. 1 an overview illustration of a plastics-processing industrial installation, simplified, for illustrative purposes only:

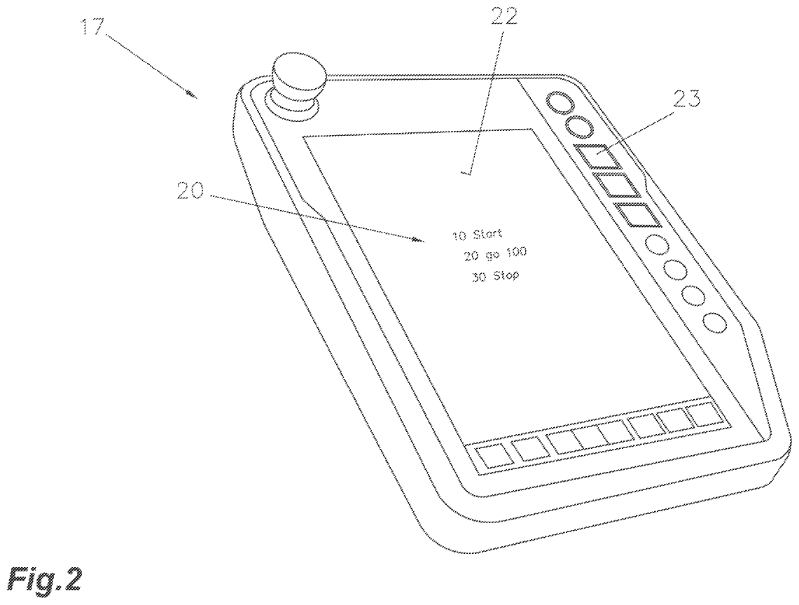

FIG. 2 a schematic representation of a teaching or program creation, respectively, on a robot controller, simplified, for illustrative purposes only;

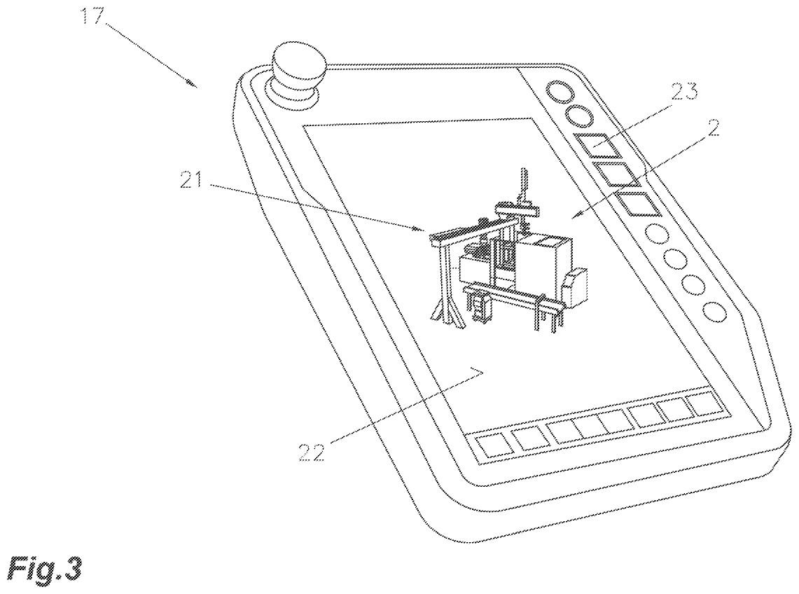

FIG. 3 a schematic representation of a virtual robot model on a robot controller, simplified, for illustrative purposes only;

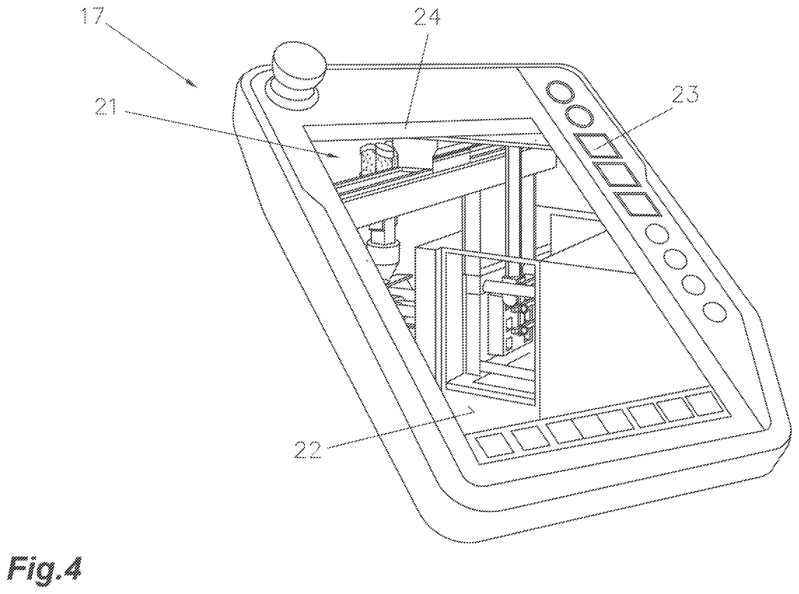

FIG. 4 a schematic representation of the robot model in enlarged perspective and changed position of the robot, where the gripper is extended into the tool for removing the produced injection-molded part.

It should be stated by way of introduction that, in the individual embodiments, the same parts are provided with the same reference numbers or same component designations, wherein the disclosures contained in the entire description can, by analogy, be transferred to identical parts with identical reference numbers or identical component designations, respectively. The position details selected in the description, such as, e.g., top, bottom, lateral, etc., likewise relate to the figure described, and in the event of a change of position, they are to be transferred to the new position by analogy. Individual features or feature combinations from the exemplary embodiments shown and described may also represent independent inventive solutions.

FIG. 1 shows an industrial installation 1, in particular a work cell 2 for injection molding applications, in which the individual components/devices for producing one or several products/semi-finished products or injection-molded parts 3 are interconnected in work cell 2. The processing machine preferably used is an injection molding machine 4, to which a robot 5 or automatic handling robot, respectively, is assigned for removing the produced injection-molded part 3, wherein the injection-molded part 3 is taken from an opening injection mold 7 by an extraction device 6, in particular a gripper equipped with gripping tongs or suction nozzles, and deposited on a device, in particular a conveyor belt 8. In order to be able to produce an injection-molded part 3, plastic granules 9 are fed to the processing machine 4 via a granules-conveying device 10 and possibly via a metering device 11. By means of a temperature control unit 13 and/or cooling unit, the injection mold can be kept at operating temperature by feeding a temperature control medium or heated or cooled accordingly, respectively, so that optimum processing of the plastic granules 9, which must be plasticized for injection into the injection mold 7, is made possible. In addition, the plant is equipped with a monitoring device 15, in particular a camera system, in order to be able to carry out an automatic quality control of the produced product 3. In order for the individual devices to be adjusted or programmed, respectively, they have corresponding control electronics, which are entered and displayed via displays 16 or a robot controller 17 arranged on the devices. For the sake of completeness, it is also mentioned that all devices are connected to corresponding lines, in particular power supply, network lines, liquid supply lines, material lines, etc., which in the interest of clarity were not displayed in the representation shown.

According to FIGS. 2 to 4, a method and a robot 5 and/or robot controller 17 are described according to the present invention, in which validation of programmed workflow sequences or teaching programs 20 of the robot 5 or handling robot, respectively, can be carried out preferably with the robot controller 17. The robot 5 is preferably mounted on or next to the processing machine, in particular the injection molding machine 4, and serves for the extraction, handling, manipulation or further processing of injection-molded parts 3 which have just been produced.

The robot controller 17 is designed to reproduce a virtual twin or virtual robot model 21 (according to FIG. 3), in particular a virtual representation of the plant or work cell, respectively, at the output location, in particular a touch screen 22, whereby preferably all production resources of the plant or work cell 2 are shown. The creation of the virtual general view can preferably be carried out automatically, whereby the required data are read out from the individual components by the robot controller 17. The virtual robot model 21, the so-called “digital twin”, is in any case automatically created from the configuration file 27 of the robot controller 17. Here it is also possible that, on the basis of stored and read-out identifiers or type designations of the devices, respectively, corresponding virtual models, in particular their shape and dimensions, are stored in the storage system of the robot controller 17, or that data for the design, in particular the arrangement, the position and the function, as well as a digital representation of the production resources are stored in the individual recorded production resources, which can be queried by the robot controller 17 and/or the robot 5 via a processing network.

The robot controller 17 is equipped with the latest hardware and software technologies with regard to increased performance and operational safety. This makes it possible that a digital robot twin, i.e. the virtual robot model 21, is available by default on the robot controller 17, which allows validation of the workflow sequences to be executed by the real robot 5 at any time in a virtual manner and thus to check the workflow sequences before start-up without risk to the processing machine and robot 5, as shown in the illustrations in FIG. 3 and FIG. 4, where the extraction device 6 of the robot 5 from the position above the injection mold 7 of the injection molding machine 4, according to FIG. 3 is extended into the opened injection mold 7 of the injection molding machine 4, according to FIG. 4.

It is essential that the robot controller 17 makes the actual specifications of the stored teaching program 20 available to the virtual robot model 21, so that the actual process is displayed on the virtual robot model 21.

The robot controller offers a display area of e.g. 10.1″ in portrait format and has a capacitive touch surface of the touch screen 21 that follows the current tablet trend. This now also allows gesture control, in particular wiping for changing sides and zooming with two fingers (as was done in FIG. 4), which makes operation of the robot controller 17 even more intuitive. Preferably, the robot controller 17 has several multi-core processors, which allow optimal task sharing and thus improve performance. Time- or safety-relevant processes, respectively, can be completely decoupled from the visualization level in order to realize maximum operational safety and the fastest possible reaction to critical events.

Based on the programming, i.e. the stored teaching program 20, the robot controller 17 generates a virtual work cell or the robot model 21, respectively, in whose visualization it is possible to zoom, whereby the perspective is freely selectable and can be changed at any time, i.e. during a simulation, i.e. a virtual sequence of machine settings, the view of the displayed robot model 21 can be changed at any time to control areas that are not visible in this way. It is also possible to zoom into the displayed model, so that only a part of the virtual robot model 17 is visible, but the simulation is continued, so that all processes become visible again when you reduce the size.

It can therefore be said that a digital copy, i.e. a digital twin or virtual robot model 21, of the actual work cell 2 or robot 5, respectively, is carried along or simulated in the robot controller 17 or the robot controller 17 is designed to display the virtual robot model 21 accordingly. This virtual robot model 21 has the same equipment features and characteristics as the real existing robot 5, and thus allows a realistic simulation of the application-specific processes.

It is always possible to check sequences when programming a teaching program 20, i.e. as soon as corresponding parts of a robot program or teaching program 20, respectively, have been created, it is possible to switch to simulation mode via the test menu of the robot controller 17, which can be called up, for example, by activating a button 23, and to check the partial sequence that has just been created. In order to clearly distinguish the virtual robot model 21 on the touch screen from the real equipment, i.e. the physical robot, a bright status line 24 preferably appears on the screen of the robot controller 17 in this mode, and the virtual robot is also shown in a schematic representation.

The simulation mode also allows simulation of the injection molding machine 4 on the basis of stored parameters, which are queried by the robot controller 17 and read out e.g. from a storage system in the injection molding machine 4. Of course, it is also possible to simulate other components or to read out their data and implement them in a virtual manner, respectively.

The simulation mode thus enables the operator or machine setter, respectively, to detect any serious errors in the robot program 20 very quickly, without having to take any risks during an actually performed test run. Movement sequences of high complexity, which are composed of up to six simultaneous movements, such as the movements of all robot axes and additional axes, such as rotary axes, and which could lead to a collision of robot 5 with the protective enclosure 25 or the tie bars 26 of injection molding machine 4, can thus be easily checked so that they lose their programming “horror”. In this way, errors in the flow logic can be detected during simulation, as well as potential synchronization problems with superimposed and simultaneously running functions.

The virtual robot model 21 is available in every operating mode for the entire process, i.e. also in the so-called “dry operation” and manual or single-step mode, respectively. It is also possible for the robot controller 17 to activate its anti-collision control in manual mode and during a dry cycle. This permanently reports the current consumption of each individual drive. If there are too many deviations from the standard value and thus collision of robot 5 with other components in work cell 2 is highly probable, the drives are switched off immediately. Thus, the actual values can be displayed or shown on the virtual robot model 21 for the corresponding parts, i.e. that, for example, if a drive has a critical current consumption, it is colored red in the virtual robot model 21 so that the operator or machine operator, respectively, can see where the limit values are exceeded or where there are problems. It is possible to have corresponding ranges for the parameter values stored and saved, respectively, so that the corresponding parts are colored appropriately. This increases user-friendliness considerably, i.e. when defined limit values, i.e. the adjustable parameters, are exceeded, the corresponding components are displayed in the virtual robot model 21 in color, in particular red, or just the values are displayed.

It is pointed out that the invention is not limited to the embodiments shown, but may comprise further embodiments.

1. A robot and/or robot controller for validation of programmed workflow sequences and/or teaching programs of the robot in a work cell, wherein the robot is preferably mounted on or next to a processing machine, in particular an injection molding machine, and designed for the extraction, handling, manipulation or further processing of injection-molded parts which have just been produced, wherein the robot controller is designed to reproduce a virtual twin or robot model, respectively, in particular a virtual representation of the installation or work cell, at the output location, in particular a display or touch screen, wherein at least the injection molding machine is represented as part of the work cell, and further production resources of the plant or work cell, which are preferably automatically detected and represented.

2. The robot and/or robot controller according to claim 1, characterized in that wherein virtual models of production resources of the work cell, in particular their shape and dimensions, are stored in the robot controller, in particular in a storage system.

3. The robot and/or robot controller according claim 1, wherein data for the design, in particular the arrangement, form and function, as well as a digital representation of the production resources are stored in the individual production resources detected, which data can be queried by the robot controller and/or the robot via a processing network.

4. The robot and/or robot controller according to claim 1, wherein the perspective of the displayed virtual twin or robot model, respectively, is freely selectable in order to easily find or check possible sources of error.

5. The robot and/or robot controller according to claim 1, wherein the virtual robot can be coupled to the physical robot again and again after simulation of various commands of the robot controller and thereupon a further simulation run with other states can be executed.

6. The robot and/or robot controller according to claim 1, wherein the robot controller can be switched to simulation mode via a test button, in which parts of a robot program or teaching program, respectively, or the complete teaching program can be simulated.

7. The robot and/or robot controller according to claim 1, wherein for distinguishing the virtual robot model from the real equipment, i.e. the physical robot, preferably a bright frame is shown on the display of the robot controller.

8. The robot and/or robot controller according to claim 1, wherein the robot controller activates its anti-collision control in manual mode and during a dry-running cycle.

9. The robot and/or robot controller according to claim 1, characterized in that the robot controller uses the distance sensors of the anti-collision control for the automatic acquisition of the working space and thus does not depend on the transmission of data of the production resources for the generation of the virtual working space

10. The robot and/or robot controller according to claim 1, characterized in that the validation of the workflow sequences to be executed by the real robot is possible in a virtual manner at any time on the robot controller.

11. The robot and/or robot controller according to claim 1, wherein the robot controller reads out the actual configuration data of the robot and links or combines, respectively, them with the teaching program stored in the robot controller.

12. The robot and/or robot controller according to claim 1, wherein the robot controller, particular the touch surface, is designed for assistance with gesture control, in particular wiping for changing sides and zooming with two fingers.

13. The robot and/or robot controller according to claim 1, wherein when defined limit values are exceeded, the corresponding components are displayed in the virtual robot model in color, in particular red.

14. A method for validation of programmed workflow sequences or teaching programs of a robot, preferably with a robot controller, which is preferably mounted on or next to a processing machine, in particular an injection molding machine, and serves for the extraction, handling, manipulation or further processing of injection-molded parts which have just been produced, wherein in the robot controller and/or in the robot a virtual robot model, in particular a digital twin, which represents the image of the actual robot and/or of the system or work cell, respectively, is represented, wherein all the necessary data are queried and read out from the connected, components, in particular the robot, the processing machine, the tool, etc., by the robot controller for generation of the virtual plant model.

15. The method according to claim 13, wherein the robot controller is switched into a simulation mode in which all sequences are reproduced in a virtual manner taking into account the queried data and the program or teaching program, respectively, which has been created.

16. The method according to claim 13, characterized in that the robot controller uses stored configuration data from the physical robot to create the virtual robot model.

17. The method according to claim 13, wherein data for the design, in particular the arrangement, form and function, as well as a digital representation of the production resources are stored in the individual production resources, which data can be queried by the robot controller and/or the robot via a processing network.

18. The method according to claim 13, wherein the displayed perspective of the digital twin can be arbitrarily changed for better detection or pinpointing, respectively, of faults.

19. The method according to claim 13, wherein the digital twin or the virtual robot model, respectively, in particular the data, can be transferred to an external component, such as a PC or laptop.
